(19) United States
(12) Patent Application Publication
(10) Pub. No.: US 2006/0114373 A1
(43) Pub. Date: Jun. 1, 2006

(54) PLANAR LIGHT SOURCE

(76) Inventors: Yu-Chi Liu, Hsinchu County (TW); Wen-Chi Wu, Hsinchu City (TW); Yuan-Wen Liu, Hsinchu City (TW); Kung-Tung Pan, Taichung City (TW); Yui-Shin Fran, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,277

(22) Filed: Mar. 28, 2005

(30) Foreign Application Priority Data
Nov. 26, 2004 (TW) 93136433

(51) Int. Cl. G02F 1/1335

(52) U.S. Cl. 349/70

(57) ABSTRACT

A planar light source including a transflective film, a plurality of cold cathode fluorescence flat lamps and at least one reflective component to provide a uniform light source is described. A portion of the light emitted from the emitting areas of the cold cathode fluorescence flat lamps passes through the transflective film, and the other portion of the light is reflected to the reflective component by the transflective film. Then, the light is reflected to the dark areas between the emitting areas to compensate the brightness of the dark areas. When the brightness of the dark areas is compensated, the planar light source provides a uniform light without dark stripes.

### CROSS-REFERENCE TO RELATED APPLICATION

This application claims the priority benefit of Taiwan application serial no. 93136433, filed Nov. 26, 2004.

### BACKGROUND OF THE INVENTION

1. Field of the Invention

The present invention generally relates to a planar light source. More particularly, the present invention relates to a planar light source composed of a plurality of cold cathode flat fluorescent lamps (CCFFLs).

2. Description of Related Art

Along with the advancement of the industry, mobile phones, digital cameras, digital video cameras, notebooks, desktop computers and other digitized tools, etc, are all being developed to be more convenient, more functional and to have appealing appearances. The display screens of the mobile phone, the digital camera, the digital video camera, the notebook and the desktop computer are an indispensable communicating interface between the user and the machine, which allows the user to operate these products more conveniently. Recently, most screens of the mobile phone, the digital camera, the digital video camera, the notebook and the desktop computer are liquid crystal displays (LCDs), a mainstream of display devices. However, since the LCDs do not have a light-emitting function themselves, a backlight module is mandated for providing a light source underneath the LCD to achieve the display function.

A conventional common backlight module includes a lamp, a reflective holder and a light-guided plate. The light-guided plate may allow a linear light source emitting from the lamp to be converted to a planar light source. However, since the lamp is disposed at the side of the light-guided plate, the uniformity of the planar light source emitting from the light-guided plate is thus inferior. Consequently, several layers of optical films (such as a diffuser plate, a brightness enhancement plate, etc,) are required to be disposed on a light-emitting surface of the light-guided plate. Thus, the cost of the backlight module is raised because the prices of the light-guided plate and the optical films are expensive. In addition, since the lamp, the reflective holder, and the light-guided plate are individual members, a glue frame is required to securely mount the lamp, the reflective holder, and the light-guided plate. Hence, from the above description, an assembling process of the backlight module is complicated, and the assembling cost can be further raised. Therefore, the cold cathode flat fluorescent lamp (CCFFL) becomes one of mainstreams of the backlight module.

The CCFFL is a plasma light-emitting device, which mainly employs the collision between electrons emitting from a cathode and an inert gas disposed between the cathode and an anode in a gas discharge chamber, thereby ionizing and activating the inert gas to form a plasma. Next, the activated atoms in the plasma will return to a ground state in a way of radiating UV light, which in turn further activates the fluorescent of the CCFFL to generate visible light. Since the CCFFL has a low thermal dissipation, an excellent light-emitting efficiency and a light uniformity, the CCFFL has been applied to the backlight source of the LCDs or other applications. In general, the manufacturing of a larger size CCFFL is difficult. Further, the problems of high manufacturing cost and low yield will be encountered when the CCFFL is applied in the large size display devices or illuminating devices. Based on the reasons described above, the CCFFL is usually applied in the medium and small size display devices.

### SUMMARY OF THE INVENTION

Accordingly, the present invention is directed to provide a planar light source, suitable for providing a planar light source with a uniform brightness.

The present invention is further directed to provide an LCD, which has a planar light source with a uniform brightness, suitable for providing a better image quality.

A planar light source of the present invention is provided. The planar light source comprises a transflective film, a plurality of cathode fluorescence flat lamps and at least one reflective component. The plurality of cathode fluorescence flat lamps is arranged uderneath the transflective film and each cathode fluorescence flat lamp has a light-emitting area. The reflective component is arranged underneath the transmitting sections of the transflective film and between the light-emitting areas.

In one embodiment of the present invention, the transflective film has, for example, a plurality of transmitting sections and a plurality of half-transmitting sections.

In one embodiment of the present invention, a portion of the light emitting from the CCFFL is reflected by the half-transmitting sections and then the reflective components and is emitted through the transflective film disposed over the reflective component, while the other portion of the light emitting from the cold cathode flat fluorescent lamp (CCFFL) directly passes through the transflective film.

In one embodiment of the present invention, each half-transmitting section has a protrusion structure, for example, a trasflective surface facing the reflective components.

In one embodiment of the present invention, the trasflective surface comprises, for example, a transflective curve surface or a plurality of transflective planes.

In one embodiment of the present invention, the protrusion structure comprises, for example, a cone shape protrusion structure or a strip shape protrusion structure.

In one embodiment of the present invention, the half-transmitting sections further comprise a patterned reflective layer disposed over the transflective film.

In one embodiment of the present invention, the reflective components have, for example, a plurality of reflective surfaces.

In one embodiment of the present invention, the reflective components comprise, for example, at least one pyramid shape structure or at least one cone shape structure.

In one embodiment of the present invention, the reflective components comprise at least one strip element.

The present invention provides an LCD, which comprises a liquid crystal panel and a planar light source. The planar light source comprises a transflective film, a plurality of CCFFLs and at least one reflective component. The CCFFLs are disposed underneath the transflective film and each CCFFL has a light-emitting area. In addition, the reflective component is disposed underneath the transflective film and between the light-emitting areas.

In one embodiment of the present invention, the transflective film has, for example, a plurality of transmitting sections and a plurality of half-transmitting sections.

In one embodiment of the present invention, a portion of the light emitting from the CCFFL is reflected by the half-transmitting sections and then the reflective components, passing through the transflective film disposed over the reflective components while the other portion of light emitting from the CCFFL directly passes through the transflective film.

In one embodiment of the present invention, each half-transmitting section has a protrusion structure, which has, for example, a trasflective surface facing the reflective components.

In one embodiment of the present invention, the trasflective surface comprises, for example, a transflective curve surface or a plurality of transflective planes.

In one embodiment of the present invention, the protrusion structure comprises, for example, a cone shape protrusion structure or a strip shape protrusion structure.

In one embodiment of the present invention, the half-transmitting sections further comprise a patterned reflective layer disposed over the transflective film.

In one embodiment of the present invention, the reflective components have, for example, a plurality of reflective surfaces.

In one embodiment of the present invention, the reflective components comprise, for example, at least one pyramid shape structure or at least one cone shape structure.

In one embodiment of the present invention, the reflective components comprise at least one strip element.

In one embodiment of the present invention, the LCD further comprises at least one optical thin film disposed between the liquid crystal panel and the transflective film.

According to the present invention, a portion of the light emitting from the CCFFL is reflected by the transflective film and the reflective component and is emitted through the transflective film disposed over the reflective component. Conseuqently, the brightness of the light-emitting surface over a non-emitting area is compensated. In conclusion, the present invention employs the design of the transflective film and the reflective components to compensate the brightness over the non-emitting area so that a planar source with a large size and uniform brightness can be obtained by the way of assembling a plurality of CCFFLs.

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross sectional side view of a planar light source according to the first embodiment of the present invention.

FIG. 1B is a diagram illustrating the arrangement of the CCFFLs according to of the first embodiment of the present invention.

FIG. 2A˜2E shows the planar source and individual members according to the first embodiment of the present invention.

FIG. 3 is a cross sectional view of a planar light source according to the second embodiment of the present invention.

FIG. 4 is a diagram illustrating the configuration of the reflective layer according to the second embodiment of the present invention.

FIG. 5 is a cross sectional view of a planar light source, according to the third embodiment of the present invention.

FIG. 6 is a cross sectional view of the LCD, according to the fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

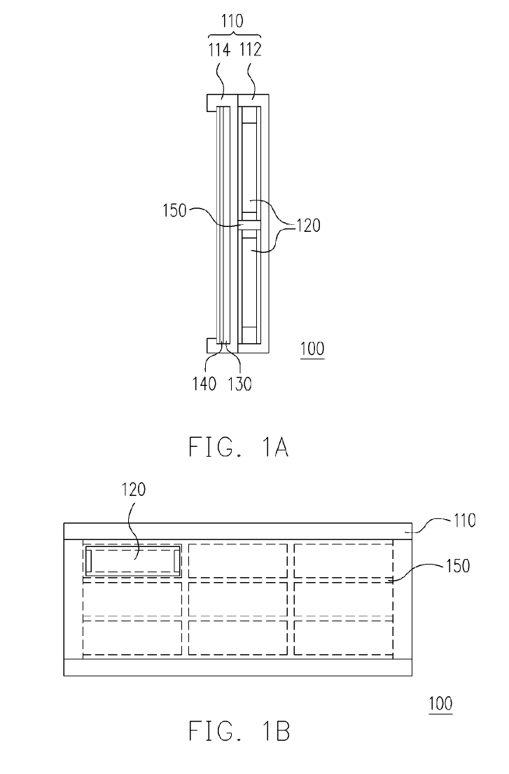

FIG. 1A is a cross sectional side view of a planar light source of the first embodiment, according to the present invention. Referring to FIG. 1, a planar light source 100 of the embodiment comprises, for example, an outer frame 110, a plurality of cold cathode flat fluorescent lamps (CCFFLs) 120, a diffuser plate 130 and at least one optical film plate 140. The outer frame 110 is constructed with a light source frame 112 and an optical film frame 114. The diffuser plate 130 and other optical film plates 140 are assembled into the optical film frame 114 disposed on a light-emitting surface of the light source frame 112. Furthermore, the diffuser plate 130 is disposed between the optical film plates 140 and the CCFFLs 120. In the embodiment, the optical film plates 140 may be, for example, a diffuser film plate and a prism film plate.

FIG. 1B is a diagram illustrating the arrangement of the CCFFLs according to the first embodiment of the present invention. Referring to FIG. 1B, the CCFFLs 120 may be assembled into the outer frame 110, for example, in a matrix arrangement manner, wherein the length of the outer frame 110 may be, for example, an integer multiple of that of each CCFFL and the width of the outer frame 110 may be, for example, an integer multiple of that of each CCFFL 120. According to this embodiment of the invention, the planar light source 100 is fabricated by assembling the CCFFLs having a small size and low manufacturing difficulties in a matrix arrangement to form a planar light source with a large size. The present invention is thus more advantageous in managing manufacturing difficulties and in structure strength when compared to a single one CCFFL with a large size.

From the above description, the planar light source 100 of this embodiment provides the planar light source with a larger size. Further, since the manufacturing thereof is conducted by assembling the CCFFLs with a small size, better yield is resulted. It is noted that since the planar source 100 employs a matrix arrangement to assemble the CCFFLs into the outer frame 110, there are low brightness areas spontaneously occurring between the CCFFLs, which further results in non-uniformity in brightness. Although this problem can be solved by increasing a vertical distance between the CCFFLs and the optical film plates 140, such a configuration will result in reducing the brightness of the light-emitting surface and increasing the total thickness of the planar light source 100. Accordingly, this embodiment provides a solution for a uniform light source of the planar light source 100.

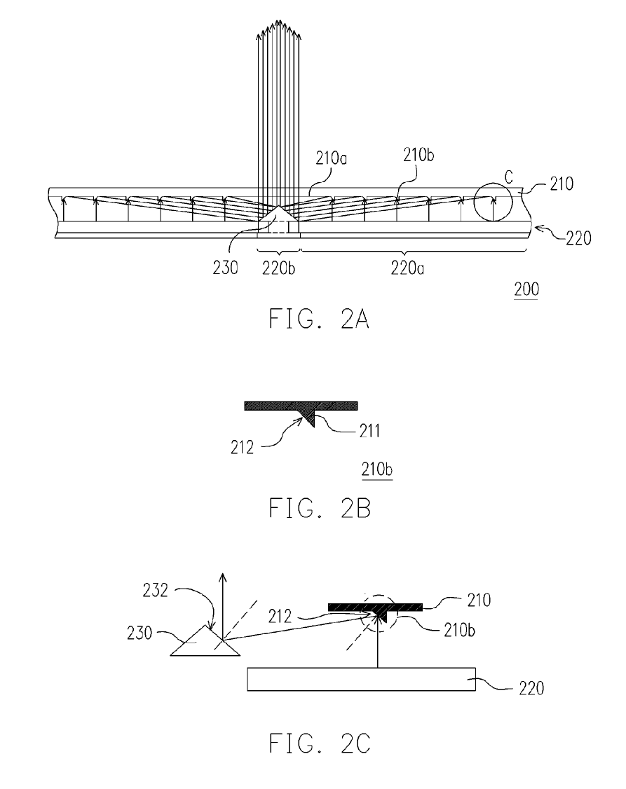

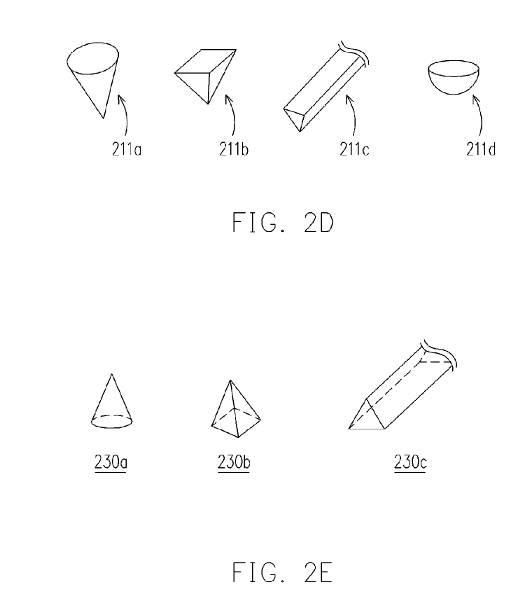

FIG. 2A is a cross sectional view of the planar light source of the first embodiment of the present invention. Referring to FIG. 2A, a planar light source 200 of the embodiment comprises a transflective film 210, a plurality of CCFFLs 220 and at least one reflective component 230. The transflective film 210 has a plurality of transmitting sections and a plurality of half-transmitting sections and the CCFFLs 220 are disposed underneath the transflective film 210. In this embodiment, each CCFFL has a light-emitting area 220a. In addition, the reflective component 230 is disposed underneath the transflective film 210 and located between light-emitting areas 220a of each CCFFL 220.

Also referring to FIG. 2A, in the embodiment, areas between light-emitting areas 220a of each CCFFL 220 are defined as non-emitting areas 220b. In other words, the non-emitting areas 220b defined in this embodiment comprise, for example, a fringe of the CCFFL and the areas between each CCFFL 220, or only the areas between each CCFFL 220.

FIG. 2B is a cross sectional view of the half-transmitting sections of the reflective film shown in FIG. 2A and FIG. 2C is an enlarged diagram of the C area in FIG. 2A. Referring to FIG. 2A, FIG. 2B and FIG. 2c simultaneously, in this embodiment, the half-transmitting sections 210b of the transflective film 210 may be, for example, a protrusion structure 211, which has a transflective surface 212 facing the reflective component 230.

It is obvious from FIG. 2A, FIG. 2B and FIG. 2c that a portion of light emitting from the CCFFL 220 is reflected to the reflective component 230 by the half-transmitting sections 210b, then reflected to the transmitting sections 210a of the transflective film 210 by the reflective components 230, and finally emitted through the transmitting sections 210a. The brightness over the non-emitting areas 220b is thereby compensated. In the embodiment, the reflective components 230 have, for example, a reflective surface 232 (shown in FIG. 2C), which may be, for example, parallel to a transflective surface 212 of the half-transmitting sections 210b. Such a design may allow the light reflected from the half-transmitting sections 210b to be reflected by the reflective surface 232 of the reflective component 230 and emitted through the reflective components 230 to compensate the brightness over the reflective component 230. As described above, the other portion of the light emitting from the CCFFL 220 will pass through the transflective film 210 to provide an illumination over the light-emitting area 220a.

FIG. 2D illustrates the possible geometric shapes of the protrusions shown in FIG. 2B. Referring to FIG. 2B and FIG. 2D, the protrusions 211 of this embodiment may be, for example, a cone shape structure 211a, a pyramid shape structure 211b, a strip shape structure 211c or a semispherical structure 211d etc,.

FIG. 2E shows the possible geometric shapes of the reflective components 230 shown in FIG. 2A. The reflective components 230 of the embodiment, for example, are constructed with one or more than one cone shape reflective components 230a, one or more than one pyramid shape reflective components 230b or one or more than one stripe shape reflective components 230c. However, those skilled in the art should realize that the protrusion structure 211 and the reflective components 230 described above may have other structural designs.

### The Second Embodiment

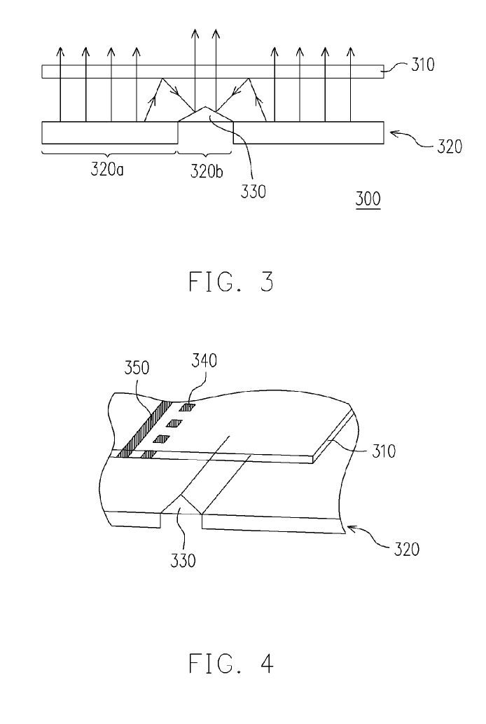

FIG. 3 is a cross sectional view of a planar source according to the second embodiment of the present invention. Referring to FIG. 3, a planar source 300 of the embodiment comprises a transflective film 310, a plurality of CCFFLs 320 and at least one reflective component 330. The planar light source 300 of this embodiment is similar to the planar light source 200 of the first embodiment except that the reflective films 310 employed by this embodiment are not designed to have the transflective surface 212 (as shown in FIG. 2B and FIG. 2C). A portion of the light emitting from the CCFFLs 320 of the embodiment can be reflected between the CCFFLs 320 and the transflective film 310 by using the transflective film constructed with an approximately chosen material. Finally, the reflected light is again reflected by the reflective components 330 and is emitted through the transflective film 310 disposed over the reflective component 330 to achieve the purpose of brightness compensation.

In other words, the portion of light emitted from the CCFFLs is reflected by the transflective film 310 and the reflective component 330. The light is directed from the light-emitting areas 320a to non-emitting areas 320b and eventually passes through the transflective film 310 disposed over the non-emitting areas 320b.

FIG. 4 is a diagram illustrating the configuration of the reflective layer of the second embodiment, according to the present invention. Referring concurrently to FIG. 3 and FIG. 4, besides the manufacturing of the transflective surface 212 is omitted, the planar light source 300 of this embodiment may further provide a spotted pattern reflective layer 340 or/and a strip reflective layer 350 disposed on the transflective film 310, thereby further raising the amount of the light being reflected to the reflective components 330.

### The Third Embodiment

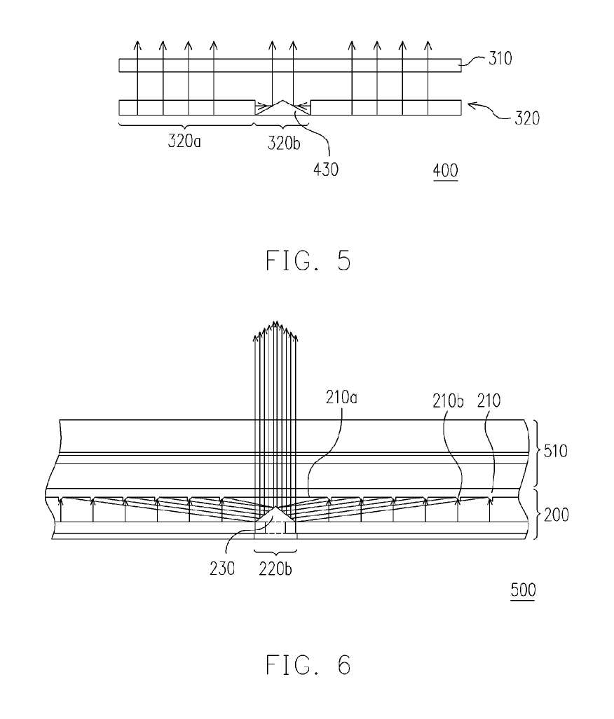

FIG. 5 is a cross sectional view of a planar light source according to of the third embodiment the present invention. Referring to FIG. 5, the planar light source 400 of this embodiment is similar to the planar light source 300 of the second embodiment, except that the reflective component 430 of the planar light source 400 of the embodiment is disposed between each CCFFL and at the same level as the CCFFLs.

In this embodiment, the reflective component may efficiently employ the light emitting from the fringes of the CCFLs to compensate the light brightness over the reflective components 430.

### The Fourth Embodiment

FIG. 6 is a cross sectional view of the LCD 500 according to the fourth embodiment of the present invention. Referring to FIG. 6, an LCD of this embodiment comprises a liquid crystal panel 510 and a planar light source 200, wherein the liquid crystal panel 510 may be, for example, a transmissive LCD panel or a transflective LCD panel. Furthermore, similar to the second embodiment, the planar light source 200a relies on a portion of light emitting from the light-emitting areas 220a to compensate the brightness over the non-emitting area 220b by using the half-transmitting sections 210 of the transflective film 210b and the reflective components 230. Accordingly, a planar light source with a uniform brightness and the LCD screen 500 having desirable image quality are provided.

The LCD of this embodiment may employs the planar light sources 300, 400 of the second and the third embodiments, in addition to the planar light source 200 of the first embodiment.

In conclusion, the tranflective film of the present invention allows a portion of the light emitting from the light-emitting areas to pass through to provide illumination above the light-emitting area. Concurrently, the tranflective film reflects the other portion of the light and then converges the light to the reflective component disposed over the non-emitting areas to compensate the brightness over the non-emitting areas of the planar light source by using the reflective component to reflect the converged light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A planar light source, comprising:
a transflective film;
a plurality of cold cathode flat fluorescent lamps (CCFFLs), disposed underneath the transflective film and each CCFFL having a light-emitting area; and
at least one reflective component, disposed underneath the transflective film and between the light-emitting areas.

2. The planar light source according to claim 1, wherein the transflective film has a plurality of transmitting sections and a plurality of half-transmitting sections.

3. The planar light source according to claim 2, wherein a portion of the light emitting from the CCFFLs is reflected by the transflective film and the reflective component and passes through the transflective film disposed over the reflective components, while the other portion of the light emitting from the CCFFLs directly passes through the transflective film.

4. The planar light source according to claim 2, wherein each half-transmitting section has a protrusion structure having a transflective surface facing the reflective components.

5. The planar light source according to claim 4, wherein the transflective surface comprises a transflective curve surface or a plurality of transflective planes.

6. The planar light source according to claim 4, wherein the protrusion structure comprises a cone shape protrusion structure or a strip shape protrusion structure.

7. The planar light source according to claim 2, wherein the half-transmitting sections comprise a patterned reflective layer disposed on the transflective film.

8. The planar light source according to claim 1, wherein the reflective components have a plurality of reflective surfaces.

9. The planar light source according to claim 8, wherein the reflective components comprise at least one pyramid shape structure or at least one cone shape structure.

10. The planar light source according to claim 8, wherein the reflective components comprise at least one strip shape element.

11. A liquid crystal display, comprising:
a liquid crystal panel;
a planar light source disposed underneath the liquid crystal panel, the planar light source comprising:
a transflective film;
a plurality of CCFFLs, disposed underneath the transflective film and each CCFFL having a light-emitting area; and
at least one reflective component, disposed underneath the transflective film and between the light-emitting areas.

12. The liquid crystal display according to claim 11, wherein the transflective film has a plurality of transmitting sections and a plurality of half-transmitting sections.

13. The liquid crystal display according to claim 12, wherein a portion of the light emitting from the CCFFLs is reflected by the transflective film and the reflective component and passes through the transflective film disposed over the reflective components, while the other portion of the light emitting from the CCFFLs directly passes through the transflective film.

14. The liquid crystal display according to claim 12, wherein each half-transmitting section has a protrusion structure comprising a transflective surface that faces the reflective components.

15. The liquid crystal display according to claim 14, wherein the transflective surface comprises a transflective curve surface or a plurality of transflective planes.

16. The liquid crystal display according to claim 14, wherein the protrusion structure comprises a cone shape protrusion structure or a strip shape protrusion structure.

17. The liquid crystal display according to claim 12, wherein the half-transmitting sections comprise a patterned reflective layer disposed on the transflective film.

18. The liquid crystal display according to claim 11, wherein the reflective components have a plurality of reflective surfaces.

19. The liquid crystal display according to claim 18, wherein the reflective components comprise at least one pyramid shape element or at least one cone shape structure.

20. The liquid crystal display according to claim 18, wherein the reflective components comprise at least one strip shape element.

21. The liquid crystal display according to claim 11, further comprising at least one optical thin film disposed between the liquid crystal panel and the transflective film.
